(19) United States
(12) Patent Application Publication
(10) Pub. No.: US 2009/0138599 A1
(43) Pub. Date: May 28, 2009

(54) Selecting Communication Channels in a Computing Device

(75) Inventor: Jonathan Allin, Cambs (GB)

Correspondence Address: Saul Ewing LLP (Philadelphia), Attn: Patent Docket Clerk, 2 North Second St., Harrisburg, PA, 17101, US

(73) Assignee: Symbian Software Limited, London (GB)

(21) Appl. No.: 12/158,106

(22) PCT Filed: Dec. 11, 2006
(86) PCT No.: PCT/GB2006/004618

§ 371 Date: Oct. 27, 2008

(30) Foreign Application Priority Data
Dec. 21, 2005 (GB) 0526050.0

(51) Int. Cl. G06F 15/173

(52) U.S. Cl. 709/226

(57) ABSTRACT

A computing device combines presence, profile, and preferences information of the originators and recipients of communications in such a way as to enable a communication session or sessions between the session originator and one or more recipients to be automatically set up over one or more channels of communication. The channel or channels that are selected are those that best fit the constraints expressed in the presence, profile, and preferences of the originators and recipients of communications.

This invention discloses a method of automatically determining and setting up the best possible communication session on a mobile computing device.

One hundred years ago, there were very limited options for communicating with another person who was not available for face-to-face contact. The normal letter post was the preferred medium, and although telegrams were widely available, they were only practical for short and urgent messages. The telephone system was still in its infancy and only gradually became a mass market product over the next few decades. As recently as twenty-five years ago, letter post, telegrams and the telephone were the only predominate means of communication for most people. Electronic mail was largely confined to those few institutions connected to ARPANET (the forerunner of today's Internet) and the majority of businesses used the international telex network for short electronic communications.

However since about 1980, the growth of both the protocols and the hardware that make up consumer computing technology has brought more and more methods of electronic communication within the reach of ordinary consumers.
In addition to fixed telephone lines, people also have the option of talking with each other over mobile cellular telephone networks.
In addition to circuit-switched fixed and mobile telephony, there is increasing use of packet-switched internet telephony (commonly known as VoIP); this can be used over fixed or wireless internet connections.
Electronic mail and text messaging on mobile telephones (SMS) are increasingly used for written communications instead of traditional letter post.
Various forms of picture communications have developed, ranging from fax to multi-media messaging (MMS); and video calls are expected to become increasingly popular.
Various forms of instant messaging (IM) are used to combine the immediacy of voice telephony with the economy of text on a one-to-one basis. Internet chat technologies enable this to be used for many-to-many communications.
Completely new communication paradigms are being introduced; for example push-to-talk over cellular networks (PoC) enables easy and inexpensive many-to-many voice communications, while whiteboarding enables many-to-many visual communications.
Context-specific communications are being introduced, such as the type of player communications used in games such as Doom 2.

In the context of the present invention, each instance of the physical media and physical interfaces together with the software protocols and software interfaces used to define these various methods are referred to as a communication channel. This invention is concerned with choosing the most suitable of these channels for any individual communication session. It should be noted that the above list of communication methods is intended to illustrate the scope of this invention only and not limit it in any way.

Modern computing devices able to make use of some or all of these communication channels include, without being limited to, desktop and laptop computers, Personal Digital Assistants (PDAs), mobile telephones, smartphones, set-top boxes and games consoles, together with converged devices incorporating the functionality of one or more of the classes of device already mentioned, as well as many other industrial and domestic electronic appliances such as digital cameras and digital music players. The most versatile computing devices, such as high-end smartphones, can use almost any communication channel conceivable.

However, the decision as to the most appropriate of the available channels for the owner or user of a computing device (the originator) to use when initiating communications with another party (the recipient) in any particular situation depends on a number of factors, including but not limited to the following:
a) the type of communication desired; for example whilst MMS or fax can be used to send an image, they cannot be used for voice calls.
b) the originator's location; trying to make a mobile cellular telephone call or send an SMS in a place where there is no cellular coverage is not worthwhile.
c) the originator's social and physical context; voice calls are unlikely to be first preference when either party is in a church service, a concert, or in an extremely noisy environment such as on a demolition site.
d) the facilities known to be available to the recipient; they may be unable to receive faxes, but may be able to receive email attachments.
e) the recipient's presence information, if available; those skilled in the art will be aware that presence technology allows people to advertise if and how they may be contacted. There is no point in trying to telephone a person when they have advertised, for example, that they are not answering voice calls.
f) the time of day; when sending non-urgent information to someone in the middle of the night, a communications channel that accepts store-and-forward data, such as voicemail, email or SMS, is far more appropriate than a channel that requires participation by the recipient, such as voice calls or instant messaging.
g) the cost of the communication; this may be variable, depending on the communications network being used, on the time of day—phone calls are often cheaper off-peak—and also on the originator's location. For example, when using internet protocols (IP) some locations may give access to free 802.11 wireless network points while other locations may only give access to chargeable ones.
h) the urgency of the communication; in an emergency, emails are less suitable than instant messaging or SMS, while in the case of non-availability of a recipient, a communication could be automatically delayed until both originator and recipient were known to be free.
i) the quality required of the communication; where accuracy is especially important, text communications are far more reliable than voice, particularly if the voice communication is in a noisy place or is over cellular networks.
j) the need for interactivity; some channels (SMS, MMS, fax, email, voicemail) are essentially one-way, while others (voice calls, PoC, IM, whiteboard) are inherently more interactive.
k) the mood or amount of time the originator has; for example, they may not have the time for a possibly lengthy interactive session such as a telephone conversation and would prefer a one-way communication such as voicemail or SMS. This may vary from recipient to recipient.

Please note that the example cases given above are intended to be illustrative rather than exhaustive. Unfortunately, there is currently no easy way for the user or owner of a computing devices seeking to originate a communication to select and then set up the most appropriate of these channels for any individual recipient with whom they wish to communicate.

It is known that there are some solutions which can partially address this problem:
Personal virtual telephone numbers, such as those described at http://ths.teleware.com/applications/in.htm or http://www.pickaweb.co.uk/070-numbers.htm or http://www.unifier2.com attempt to provide flexible communications facilities with call recipients irrespective of location. Using this solution, originators always have a single contact point (the personal telephone number) from which calls are redirected to a location or locations selected by its owning recipient; this can be a landline, a mobile number, an international number, a fax machine, a speech-to-text facility, voicemail, or an answering service (which will in turn often be instructed to send recipients emails, faxes or SMS text messages as they have previously requested).
Apart from the fact that this only really applies to telephony, it does not actually address the problem of what might be the most suitable channel for the originator; it addresses the rather different problem of what the most suitable communications channel for the recipient might be. Thus, the recipient needs to manually re-register their location every time they move, and manually provide the telephone number to which all incoming calls should be diverted. The originator is at no stage in control of the process, and the fact that the recipient appears to handle only a single type of communications channel does not allow the originator to select the most suitable communications channel for them. It is the recipient who decides to have their calls diverted to voicemail, or to an answering service that will send the content of a message as an SMS; this is done without consideration for the needs and preferences of the originator.
Presence technology (referred to above) is primarily used to convey information about a potential recipient's status to a potential originator; they could be available, available but busy, off-line, out to lunch and so on. The information conveyed by presence can also give the best means of contact; for example, if someone is out to lunch, presence information could let an originator know whether they were answering the phone or not, or whether they would be able to answer an email on their return. This technology does allows an originator to see whether the intended recipient is available, what communication channels they can utilise, and what their preferred channel might be. A description of this technology can be found at http://www.followap.com/shtml/solution_iFollow_IM &_presence_server.shtml.
However, in order for the originator to make contact with the recipient, it is still necessary for them to reconcile the presence information with their own preferences and, according to the criteria described above, then select the appropriate communication channel. This can be a lengthy manual process, because computing devices such as telephones are often slow to set up many types of communication channels (for example, multiparty calls) and the process can require considerable intervention by the originator.

It is therefore an object of the present invention to provide an improved way of selecting a communications channel in a computing device.

According to a first aspect of the present invention there is provided a method of operating a computing device by which initiation of a communications session between an originator computing device and a recipient computing device causes one or more of a plurality of available communications channels to be automatically selected.

According to a second aspect of the present invention there is provided a) computing device arranged to operate in accordance with a method of the first aspect.

According to a third aspect of the present invention there is provided an operating system for causing a computing device to operate in accordance with a method of the first aspect.

Embodiments of the present invention will now be described, by way of further example only, with reference to the accompanying drawing, in which:

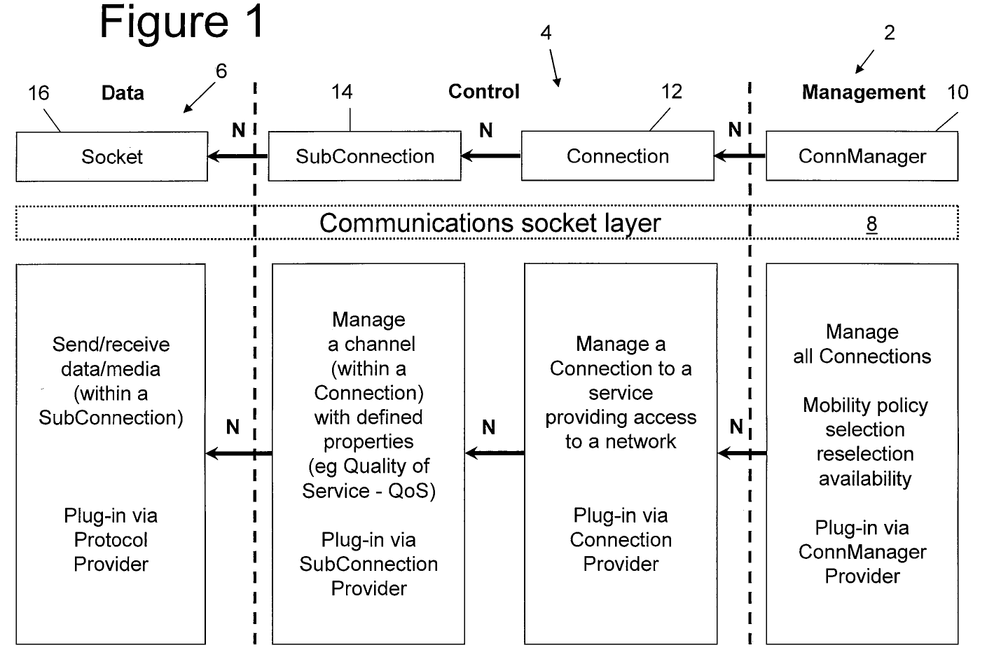

FIG. 1 shows an embodiment of a computing device architecture in accordance with the present invention.

The present invention makes it possible for much of the effort involved in selecting the most appropriate communications channel to be automated. This increases the utility of a computing device incorporating the invention, by saving time, by saving money and by helping to avoid the risk of misdirected or inappropriate attempts to communicate.

The first step in this invention is for the originator to select the intended recipient or recipients for a communication, typically from the address book or contacts application on their computing device.

The second step in this invention is for all possible information about the potential recipient or recipients to be gathered.

Some of this data may already be present on the originator's computing device; for example, their contacts database is quite likely to include information regarding a number of possible channels, together with the recipient's geographical location. More data could be accessible via the use of presence mechanisms, particularly where the recipient is using a communications device which has implemented the disclosures of patent application GB0313385.7 entitled “Automatic behaviour modifications in Symbian OS” or patent application GB0510794.1 entitled “Location Based Push Presence and Profile on a Wireless Communications Device”; these two disclosures enhance presence information and make it more accurate and comprehensive. It is possible that still more data could be gathered via various out-of-band communication mechanisms; for example, public location servers or communications networks.

The recipient information gathered can include any or all of:
a. available channels of communication
b. Signal coverage, e.g. WiFi, BT, GSM
c. battery level of their mobile devices
d. geographical location (e.g. in a restaurant, in the country)
e. preferred channel of communication
f. mood (sociable, reflective, chatty, willingness to receive a message but not to talk, willingness to play a game)
g. social context (in a meeting, in a theatre, outdoors, travelling, sleeping)
h. whether any communication channels are busy
i. time of day (local time of day; more important when the recipient is not in the same time zone as the originator).

Note that in the case where there are multiple potential recipients, this information would be automatically gathered for each one.

The third step in this invention is for the originator's specific preferences for the potential communication session to be gathered.

A list of some of the factors the might affect the choice of the most appropriate channels of communication for the originator have already been described.

Some of this information will be known immediately, because it is already present on the device as part of the device state, the originator's calendar or agenda information, or their published presence information.

Other information may be ascertained from the current device profile; these are becoming well-known on computing devices, especially on advanced mobile phones, where a number of different profiles are commonly provided. These profiles group together the way the phone behaves e.g. in respect of user alerts, which include items such as ring tones and vibration alerts. Profiles commonly have names such as ‘Meeting’ ‘Outdoor’ ‘Silent’ and of course ‘Normal’, and they tailor the device to ensure that it behaves in socially appropriate ways when in specific sets of situations. While they are commonly used to modify audible user alerts they could of course be extended to define any type of ‘situation appropriate’ behaviour for a device; for instance, key clicks can be as irritating in some situations as rings, while visible prompts can be disruptive in certain situations, such as photographic darkrooms.

Other information may be automatically obtained via methods such as those disclosed in previously referred to patent application GB0313385.7. Still more information may be obtained by a method such as those disclosed in patent application GB0510794.1, referred to above.

However, by its nature, some information may (optionally) need to be gathered on a per-session basis; this data might include:
a. What the originator wants to spend on the call (typically this will be a binary decision, charge or no charge)
b. What type of information needs to be communicated (voice, image, other data)
c. What bandwidth the originator requires (which depends on the amount of communication data expected; SMS works over low-bandwidth, while videotelephony requires high-bandwidth)
d. Whether the session needs to be interactive or one-way
e. Whether the communication is urgent or not.

Note that it is very likely that suitable defaults (possibly linked to device profiles using techniques similar to those disclosed in the previously described patent application GB0313385.7) can be set up for this type of information, thereby considerably easing the burden on the originator; with careful research and design of the user interface, it is anticipated that such defaults will prove appropriate for most communications.

The fourth step in this invention is for the information gathered in the first three steps to be reconciled. In the majority of cases, this procedure will be both simple and automatic and invisible to the user.

In some cases, however, the user might be prompted to make a decision at this point. If, for example, an interactive communication involving multiple recipients (such as a conference call) was being set up, and one of the recipients was unavailable for an interactive session, the user might reasonably be asked:
whether the session should proceed without the unavailable party
whether the entire session should be postponed until the missing party became available
whether the session should be moved to a suitable alternative non-interactive store-and-forward channel (SMS, email, or fax) for all recipients
whether only the missing recipient should be sent the communication using the alternative channel with interactive session proceeding as requested for everyone else

As described in the previous step, suitable defaults might make such interaction redundant.

The fifth step in this invention is for the originator to initiate the session; normally, this would require one single action (e.g. pressing the call button of the phone or selecting a menu entry). At this point, the innovation:
a. starts the required applications and services on the computing device. These might include SMS, chat, voice, or games.
b. connects with the recipients using the relevant applications, addresses, and protocols.

The originator is then able to communicate (e.g. to talk, text, whiteboard, or game) with the called parties, using the selected channels.

If any of the recipients are unavailable (perhaps their presence information was incorrect) the originator can be given the same options as in the fourth step above.

A sample implementation of an architecture suitable for the present invention is illustrated in FIG. 1. This architecture shows three vertical planes: a vertical plane 2 on the right of FIG. 1 signifies a management plane of a communication session, with a connection plane 4 in the centre of the FIGURE, and a data plane 6 to the left of the FIGURE. All the planes in the sample implementation shown in FIG. 1 interact with a communications socket layer 8; those skilled in the art will also be aware that sockets are a standard architecture for communications subsystems.

A ConnManager object 10 (in the management plane 2) is responsible for managing connections and gathering the information outlined in the first, second and third steps above, and using that information to define the policy to be used during the communication session. The ConnManager object 10 can be provided as a plug-in via ConnManager Provider of the system. Primarily, it is where much of the functionality of the invention is implemented. A Connection object 12 (in the control plane 4) is responsible for managing a connection to a communication service, while a SubConnection object 14 (also in the control plane 4) is responsible for choosing the best channel available within the chosen service. The Connection object 12 and SubConnection object 14 can also be provided as plug-ins, as depicted in FIG. 1. Finally, a Socket plane object (in the data plane 6) is responsible for managing the actual data within the best channel as chosen by the SubConnection object 14. This object can also be provided as a plug-in.

This architecture allows a communication session policy to be defined based on the various inputs disclosed above. Note that a prerequisite for defining such a policy is that all external policy-defining information has been or can be gathered by the computing device, and provided to the ConnManager object 10 on demand, where the various constraints are reconciled and a decision as to the most appropriate channel is made.

For simplicity, FIG. 1 does not illustrate all possible uses and scenarios, and it should be noted that it is intended to illustrate the invention rather than limit it in any way. Many other possible implementations will readily occur to those skilled in the art, who will readily understand how various use cases can be accommodated in the sample architecture shown.

An example of such a use case would be where an originator requests that a telephone conversation is established with a recipient, with an urgency constraint that it is to occur some time in the next 4 hours (a time constraint that is appropriate for both parties), and a cost constraint that the call should be made in the most economical way. The ConnManager object 10 in this case gathers availability information of both the originator and the recipient in the next 4 hours (for example, by consulting the calendar of the originator and the presence data of the recipient). The ConnManager object then determines the most economical way of connecting the two users (based on location information for both and the devices available to each). The ConnManager object then schedules the call as appropriate using whatever facilities are available in the computing device for setting timed events, triggers or alarms.

Another use case may be where an originator requests a communication with multiple recipients. In this case, the ConnManager object 10 gathers the necessary information for all users and determines the best way of connecting to them at the appropriate time. As described above, this could involve using multiple connection services for different users, in which case the ConnManager object would need to set up more than one connection for the request.

It can be realised from the above disclosure that several advantages accrue from the present invention. In essence, the present invention discloses how to combine the various constraints, possibly gathered from disparate sources, of both originators and recipients of communications. This enables single or multi recipient communications sessions to be automatically and efficiently set up with the most appropriate channels of communication. While the utility is especially advantageous when multiple recipients are involved, there are also considerable efficiency gains to be made with single recipients; all the originator has to do is select the recipient rather than their specific address or channel.

While this invention is especially applicable to mobile telephones because they tend to have the largest range of possible channels, it can be applied to any computing device able to communication over a choice of communication channels.

Although the present invention has been described with reference to particular embodiments, it will be appreciated that modifications may be effected whilst remaining within the scope of the present invention as defined by the appended claims.

1. A method of operating a computing device by which initiation of a communications session between an originator computing device and a recipient computing device causes one or more of a plurality of available communications channels to be automatically selected.

2. A method according to claim 1 wherein the selection of the communication channel or channels is made on the basis of information that the originator computing device has gathered about the situation and preferences of the originator of the communications session.

3. A method according to claim 1 wherein the selection of the communication channel or channels is based on information that the originator computing device has gathered about the situation and preferences of the recipient or recipients of the communications session.

4. A method according to claim 2 wherein the said information is gathered by the originator computing device from data stores comprising any one or more of
a. currently held hardware status information
b. currently held network status information
c. current device profiles
d. published presence information
e. preferences of the owner of the device
f. contacts data held on the device
g. status information available from networks to which the device is or can be connected; or
h. any other data stores held on either the originator or recipient devices.

5. A method according to claim 4 wherein the said information comprises constraints or preferences specific to the proposed communication.

6. A method according to claim 2 wherein the information comprises any one or more of
a. the known format or content of the communication
b. the originator or recipients' locations
c. the originator or recipients' social and physical contexts
d. the time of day
e. the time available
f. the cost of the communication
g. the urgency of the communication
h. the quality required of the communication
i. the need for interactivity.

7. A method according to claim 2 wherein the selection of a communications channel or channels is made first by ascertaining which ones are available and secondly by evaluating which of the available channels are most desirable in that they conform to or most closely match the expressed constraints and preferences of the originator.

8. A method according to claim 1 wherein, if the initiation of a communications session is not possible or desirable, it is postponed to a time which is both possible and desirable.

9. A method according to claim 1 as implemented by a connection manager incorporated in the computing device.

10. A method according to claim 9 wherein the connection manager is arranged to interface with a communication sockets component in the computing device.

11. A method according to claim 1 wherein the initiation of a single communications session results in multiple communication sessions.

12. A computing device arranged to operate in accordance with a method as claimed in claim 1.

13. An operating system for causing a computing device to operate in accordance with a method as claimed in claim 1.
